(19) United States
(12) Patent Application Publication
(10) Pub. No.: US 2021/0278668 A1
(43) Pub. Date: Sep. 9, 2021

(54) NEAR EYE DISPLAY DEVICE

(71) Applicant: Coretronic Corporation, Hsin-Chu (TW)

(72) Inventors: Chih-Wei Shih, Hsin-Chu (TW); Chung-Ting Wei, Hsin-Chu (TW); Chuan-Te Cheng, Hsin-Chu (TW)

(73) Assignee: Coretronic Corporation, Hsin-Chu (TW)

(21) Appl. No.: 16/812,370

(22) Filed: Mar. 9, 2020

(51) Int. Cl. G02B 27/01; F21V 8/00

(52) U.S. Cl. CPC G02B 27/0172; G02B 6/0018; G02B 27/0018; G02B 2027/012; G02B 6/0038

(57) ABSTRACT

The invention relates to a near eye display device. A first waveguide element includes first light splitting elements for splitting an image beam, an inclined surface, and an antireflection structure. The image beam enters the first waveguide element from a first light input surface. The image beam, after being reflected by the inclined surface, is transmitted to the first light splitting elements and leaves the first waveguide element from a first light output surface. A distance is provided between the first light input surface and a second light output surface. The antireflection structure is located in a connected region of the first light input surface and the inclined surface and is configured to eliminate the condition that a part of the image beam incident from the first light input surface is reflected twice on the inclined surface to solve the problem of ghost image and provide high display quality.

### BACKGROUND OF THE INVENTION

### 1. Field of the Invention

The invention generally relates to a head-mounted display device, in particular, to a near eye display device.

### 2. Description of Related Art

A near eye display (NED) may be applied to a display system of a head-mounted display (HMD), and is a next-generation killer product with great development potential at present. At present, near eye display technologies may be divided into an augmented reality (AR) technology and a virtual reality (VR) technology according to related application. For the augmented reality technology, related developers are currently committed to providing optimal image quality on the premise of light weights and small sizes of near eye displays.

In an optical architecture for implementing augmented reality by use of a near eye display, an image beam for display, after being emitted by a projection device, is reflected into an eye of a user through a transflective optical element. Both the display image beam and an external ambient beam may enter the eye of the user to achieve an augmented reality display effect. However, a user often encounters the condition that a display picture has a ghost image in a process of using a conventional near eye display. That is, the user may not only see an originally expected picture but also see an unexpected picture. Therefore, how to avoid a ghost image of a display picture provided by a near eye display and achieve a relatively good line of sight range and visual quality to enable the near eye display to provide a good user experience is one of important subjects at present.

The information disclosed in this Description of Related Art section is only for enhancement of understanding of the background of the described technology and therefore it may contain information that does not form the prior art that is already known to a person of ordinary skill in the art. Further, the information disclosed in the Description of Related Art section does not mean that one or more problems to be resolved by one or more embodiments of the invention were acknowledged by a person of ordinary skill in the art.

### SUMMARY OF THE INVENTION

Embodiments of the invention provide a near eye display device, which may effectively solve the problem of ghost image caused by secondarily reflected stray light and provide high display quality.

Other objectives and advantages of the invention may be further understood from the technical features disclosed in the invention.

In order to achieve one or part or all of the foregoing objectives or other objectives, an embodiment of the invention discloses a near eye display device. The near eye display device includes a display, a first waveguide element and a second waveguide element. The display is configured to provide an image beam. The first waveguide element is configured on a transmission path of the image beam, and includes a first light input surface, a first light output surface, an inclined surface, a plurality of first light splitting elements and an antireflection structure. The second waveguide element is configured on the transmission path of the image beam and located between the display and the first waveguide element. The second waveguide element includes a second light input surface, a second light output surface and a plurality of second light splitting elements. The image beam enters the second waveguide element from the second light input surface, is transmitted to these second light splitting elements and leaves the second waveguide element from the second light output surface. The image beam enters the first waveguide element from the first light input surface, and the image beam, after being reflected by the inclined surface, is transmitted to these first light splitting elements and leaves the first waveguide element from the first light output surface. A distance is provided between the first light input surface and the second light output surface. The antireflection structure is located in a connected region of the first light input surface and the inclined surface, and the antireflection structure eliminates part of the image beam incident on the connected region of the first light input surface and the inclined surface.

Another embodiment of the invention discloses a near eye display device. The near eye display device includes a display and a first waveguide element. The display is configured to provide an image beam. The first waveguide element is configured on a transmission path of the image beam, and includes a first light input surface, a first light output surface, an inclined surface, a plurality of first light splitting elements and an antireflection structure. The image beam enters the first waveguide element from the first light input surface, and the image beam, after being reflected by the inclined surface, is transmitted to these first light splitting elements and leaves the first waveguide element from the first light output surface for transmission into a human eye. The antireflection structure is located in a connected region of the first light input surface and the inclined surface, and the antireflection structure eliminates part of the image beam incident from the first light input surface.

Based on the above, the near eye display device of the embodiments of the invention includes the antireflection structure so that the condition that the incident image beam to the first waveguide element is reflected twice on the inclined surface may be eliminated, an unexpected light may further be prevented from entering a projection object, the problem of ghost image caused by secondarily reflected stray light may be effectively solved, and high display quality may be provided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic solid diagram of a near eye display device according to an embodiment of the invention.

FIG. 2 is a schematic side view of the near eye display device in FIG. 1.

FIG. 3 is a schematic diagram of polarization directions of an image beam in different waveguide elements according to an embodiment of the invention.

FIG. 4 is a schematic outline diagram that an image beam is incident to a waveguide element configured without any antireflection structure according to an embodiment of the invention.

FIG. 5 is a schematic outline diagram of a near eye display device according to an embodiment of the invention.

FIG. 6 is a schematic outline diagram of a near eye display device according to an embodiment of the invention.

FIG. 7 is a schematic outline diagram of a near eye display device according to an embodiment of the invention.

FIG. 8A is a schematic outline diagram of a near eye display device according to an embodiment of the invention.

FIG. 8B is a schematic outline diagram of a near eye display device according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

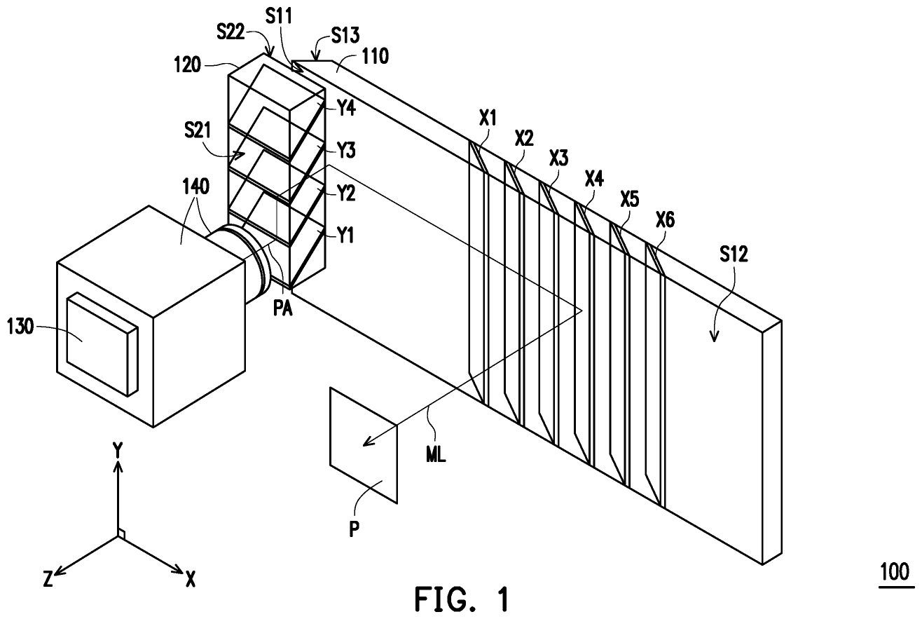

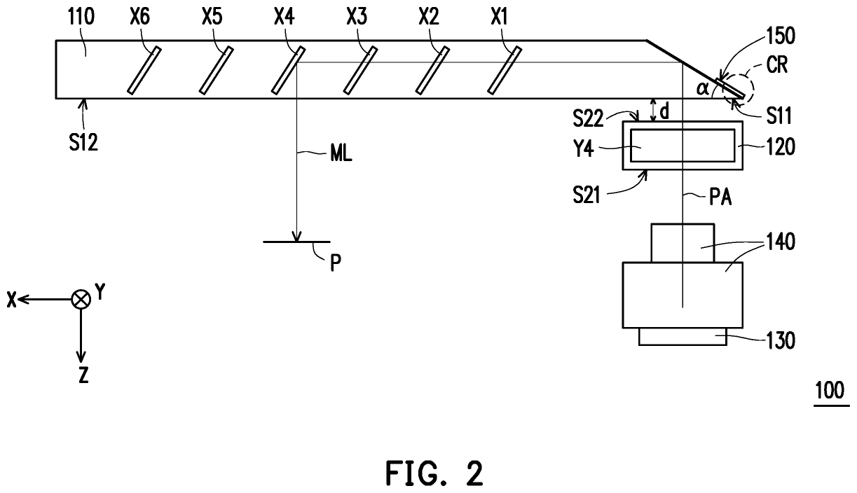

FIG. 1 is a schematic solid diagram of a near eye display device according to an embodiment of the invention. FIG. 2 is a schematic side view of the near eye display device in FIG. 1. Referring to FIG. 1 and FIG. 2, the near eye display device 100 of the embodiment includes a first waveguide element 110, a second waveguide element 120, a display 130 and a lens module 140. The display 130 is configured to provide an image beam ML. The second waveguide element 120 is configured on a transmission path PA of the image beam ML and located between the display 130 and the first waveguide element 110. The lens module 140 is configured between the display 130 and the second waveguide element 120.

In the embodiment, the first waveguide element 110 is configured on the transmission path PA of the image beam ML, and includes a first light input surface S11, a first light output surface S12, a plurality of first light splitting elements X1, X2, X3, X4, X5 and X6, an inclined surface S13 and an antireflection structure 150. The inclined surface S13 is connected with the first light input surface S11 such that one end of the first waveguide element 110 forms a connected region CR at an included angle α. The first waveguide element 110 extends along a first direction X, and the first light splitting elements X1, X2, X3, X4, X5 and X6 are arranged along the first direction X. The number of the light splitting elements is not limited in the invention. In the embodiment, the first light input surface S11 and the first light output surface S12 are different portions located on the same surface of the first waveguide element 110. However, in other embodiments, according to a practical requirement, the first light input surface S11 and the first light output surface S12 may also be different surfaces. There are no limits made thereto in the invention.

The second waveguide element 120 includes a second light input surface S21, a second light output surface S22 and a plurality of second light splitting elements Y1, Y2, Y3 and Y4. The second waveguide element 120 extends along a second direction Y, and the second light splitting elements Y1, Y2, Y3 and Y4 are arranged along the second direction Y. The number of the light splitting elements is not limited in the invention. In the embodiment, the second light input surface S21 and the second light output surface S22 are opposite to each other. However, in other embodiments, according to different arrangement positions of an image system 130, the second light input surface S21 may also be adjacent to the second light output surface S22. There are no limits made thereto in the invention.

In the embodiment, the first light splitting elements X1, X2, X3, X4, X5 and X6 and the second light splitting elements Y1, Y2, Y3 and Y4 include transflective coatings respectively. Therefore, an optical effect that the image beam ML is partially transmitted and partially reflected at positions of the first light splitting elements X1, X2, X3, X4, X5 and X6 and the second light splitting elements Y1, Y2, Y3 and Y4 is achieved.

Each waveguide element is made of, for example, a transparent material like a transparent plastic product or glass. The number of the light splitting elements in each waveguide element and distances between the adjacent light splitting elements may be designed according to different product requirements and are not intended to limit the invention. Moreover, the number of the first light splitting elements may be the same as or different from the number of the second light splitting elements, and the distances between the adjacent light splitting elements may be the same or different. In the embodiment, an included angle between each light splitting element and the corresponding light input surface is generally equal to 30 degrees or within a range of +/−15 degrees of 30 degrees, or equal to 45 degrees or within a range of +/−15 degrees of 45 degrees, may be designed according to different product requirements and is not intended to limit the invention. In an embodiment, the included angles of each light splitting element may be equal to unequal. In addition, reflectivity of each light splitting element in an embodiment may be properly regulated according to an incident angle or a wavelength.

In the embodiment, the display 130 provides the image beam ML. The display 130 includes an image projection system such as a digital light processing™ (DLP™) projection system, a liquid-crystal display (LCD) projection system or a liquid crystal on silicon (LCoS) projection system, and there are no limits made thereto in the invention. In addition, the lens module 140 may include one or more lenses or other beam transmission elements.

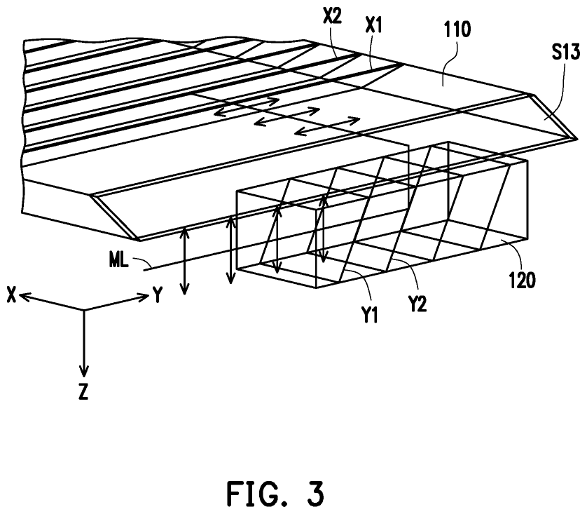

In the embodiment, the image beam ML may have a single polarization direction. Referring to FIG. 3, FIG. 3 is a schematic diagram of polarization directions of an image beam in different waveguide elements according to an embodiment of the invention. For convenient display, the antireflection structure is not shown. For example, the image beam ML entering the second waveguide element 120 may be a light with a polarization direction P (a direction like a third direction Z) for the second light splitting elements Y1, Y2, Y3 and Y4. In the embodiment, an extension direction of the first waveguide element 110 is the first direction X, an extension direction of the second waveguide element 120 is the second direction Y, and when the image beam ML with the polarization direction P leaves the second waveguide element 120 and is reflected and transmitted by the inclined surface S13 for transmission in the first waveguide element 110, the polarization direction of the image beam ML in the first waveguide element 110 is a polarization direction S (a direction like the second direction Y) for the first light splitting elements X1, X2, X3, X4, X5 and X6. Therefore, the coatings of individual first light splitting elements and second light splitting elements may be designed correspondingly to the image beam ML with the single polarization direction.

Referring to FIG. 1 and FIG. 2 again, in the embodiment, the image beam ML from the display 130 is transmitted along the third direction Z in the lens module 140, enters the second waveguide element 120 from the second light input surface S21 along the transmission path PA through the lens module 140 and is transmitted to these second light splitting elements Y1, Y2, Y3 and Y4. In the embodiment, in the second waveguide element 120, a part of the image beam ML is reflected by the second light splitting element Y1, a part of the image beam ML is transmitted by the second light splitting element Y1 and transmitted along the second direction Y, and the image beam ML, after being reflected by the second light splitting elements Y1, Y2, Y3 and Y4, leaves the second waveguide element 120 from the second light output surface S22 along the third direction Z.

Referring to FIG. 2, a distance d is formed between the first waveguide element 110 and the second waveguide element 120 in the third direction Z. More specifically, the distance d is formed between the first light input surface S11 of the first waveguide element 110 and the second light output surface S22 of the second waveguide element 120 in the third direction Z. The image beam ML, after leaving the second waveguide element 120 from the second light output surface S22, continues to be propagated along the third direction Z, enters the first waveguide element 110 from the first light input surface S11 after passing through the distance d and is transmitted to the inclined surface S13. The image beam ML, after being reflected by the inclined surface S13, is transmitted to the first light splitting elements X1, X2, X3, X4, X5 and X6. The inclined surface S13 has, for example, reflecting coating and may reflect the beam.

In the embodiment, the image beam ML is transmitted along the first direction X in the first waveguide element 110, the image beam ML, after being transmitted and reflected by the first light splitting elements X1, X2, X3, X4, X5 and X6, leaves the first waveguide element 110 from the first light output surface S12 and is projected to a projection object P, and the projection object P is, for example, a pupil or an eye of a user. In an embodiment, the projection object P is, for example, an image sensing device receiving the image beam ML, like a charge-coupled device (CCD) or a complementary metal-oxide-semiconductor (CMOS) image sensor.

In the embodiment, the image beam ML has a corresponding viewing angle at the projection object P. The viewing angle includes, for example, a first viewing angle in the first direction X and a second viewing angle in the second direction Y. In the embodiment, a magnitude of the first viewing angle is, for example, determined by the number of the first light splitting elements in the first waveguide element 110, the distance between the first light splitting element to the last light splitting element in the first waveguide element or the distance between two adjacent light splitting elements. Similarly, a magnitude of the second viewing angle is, for example, determined by the number of the second light splitting elements in the second waveguide element 120, the distance between the first light splitting element to the last light splitting element in the second waveguide element or the distance between two adjacent light splitting elements. In the embodiment, a viewing angle in a diagonal direction of the projection object P may be determined by the first viewing angle in the first direction X and the second viewing angle in the second direction Y, and a magnitude thereof is about 20 degrees to 60 degrees. The viewing angle in the diagonal direction may be designed according to different product requirements and is not intended to limit the invention.

Based on the above, it can be seen that the image beam ML may enter the first waveguide element 110 and the second waveguide element 120, but it is likely to generate unexpected reflected light when the image beam ML is incident to the inclined surface S13 at a small angle, for example, the image beam ML is incident to the inclined surface S13 at a small angle in the first waveguide element 110, thereby forming a beam reflected more than once on the inclined surface S13.

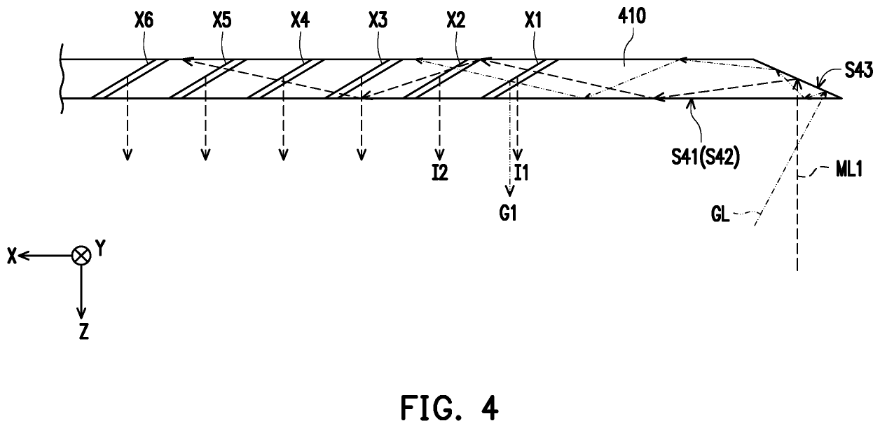

Referring to FIG. 4, FIG. 4 is a schematic outline diagram that an image beam is incident to a waveguide element configured without any antireflection structure according to an embodiment of the invention. In the embodiment, a waveguide element 410 is taken as an example. In the embodiment, the waveguide element 410 takes the structure of the first waveguide element 110 as an example.

The waveguide element 410 comprises an incident surface S41 and an emergent surface S42, and the incident surface S41 and the emergent surface S42 are located on the same surface of the waveguide element 410 but at different positions. The waveguide element 410 further includes an inclined surface S43. After an image beam ML1 and an image beam GL enter the waveguide element 410 from the incident surface S41, the inclined surface S43 may reflect the image beam ML1 and the image beam GL to transmit the image beams ML1 and GL in the waveguide element 410. The waveguide element 410 further includes a plurality of first light splitting elements X1, X2, X3, X4, X5 and X6 such that the image beam ML1 and the image beam GL leave the waveguide element 410 from the emergent surface S42.

The image beam ML1 is an incident beam to the inclined surface S43 at a relatively large angle, and is reflected only once on the inclined surface S43, then transmitted in the waveguide element 410 and successively reflected by the first light splitting elements X1, X2, X3, X4, X5 and X6 to leave the waveguide element 410 to generate display beams I1, I2 and the like. For example, the display beams I1 and I2 are transmitted to an eye of a user such that the user sees a virtual image. Herein, the relatively large angle is, for example, larger than 30 degrees or 45 degrees, which is not limited in the invention, and those skilled in the art may determine an incident angle range suitable for the condition that reflection occurs at most once on the inclined surface S43 according to a practical condition. On the other hand, the image beam GL is an incident beam close to a connected region of the incident surface S41 and the inclined surface S43, and thus is reflected more than once on the inclined surface S43. As shown in FIG. 4, the image beam GL is transmitted in the waveguide element 410 after being secondarily reflected on the inclined surface S43, and then is reflected by the first light splitting elements X1, X2, X3, X4, X5 and X6 to leave the waveguide element 410 to generate a ghost image beam, for example, G1. G1 is called a ghost image beam because the secondarily reflected image beam GL may generate light at unexpected viewing angles and these unexpected light are kept transmitted in the waveguide element 410 and reflected into a projection object P, for example, the eye of the user, by the first light splitting elements X1, X2, X3, X4, X5 and X6. In such case, the user may not only see an originally expected picture but also see an unexpected picture. Therefore, these secondarily reflected light may make the user feel a ghost image in the picture in a process of using the near eye display. For reducing the condition of ghost image in the picture, the first waveguide element 110 of the embodiment includes the antireflection structure 150, and the antireflection structure 150 is located in the connected region CR of the first light input surface S11 and the inclined surface S13 and configured to eliminate the condition that the incident image beam GL from the first light input surface S11 may be reflected twice on the inclined surface S13. The antireflection structure 150 is, for example, a light absorption coating, and an absorption rate thereof is, for example, higher than 95%. However, the absorption rate of the light absorption coating in the invention is not limited thereto.

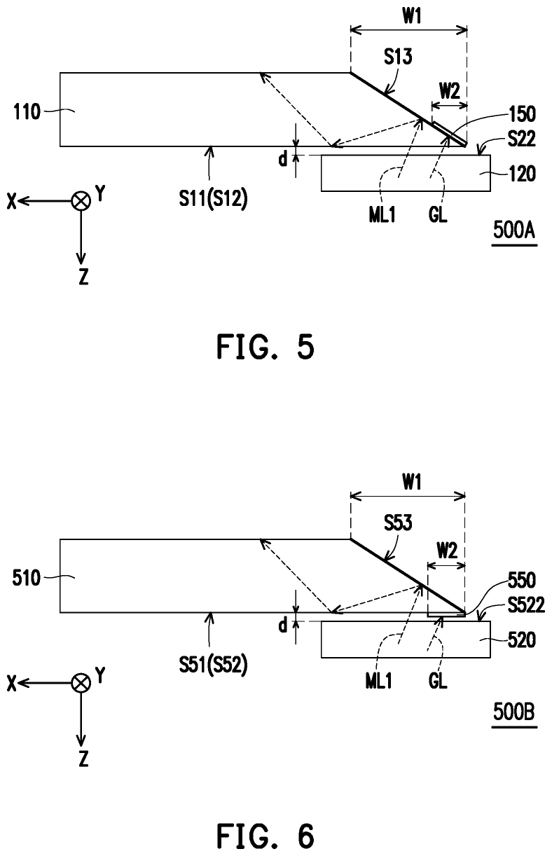

At first, referring to an embodiment shown in FIG. 5, FIG. 5 is a schematic outline diagram of a near eye display device according to an embodiment of the invention. The near eye display device in FIG. 5 may be applied to the structures shown in FIG. 1 to FIG. 3. The image beams ML1 and GL provided by the display (not shown herein) leave the second light output surface S22 of the second waveguide element 120, and enter the first waveguide element 110 from the first light input surface S11 after passing through the distance d between the second light output surface S22 and the first light input surface S11. In the embodiment, the antireflection structure 150 of the first waveguide element 110 is a light absorption coating, and is located in the connected region of the first light input surface S11 and the inclined surface S13. Specifically, in the embodiment, the antireflection structure 150 is configured at an end portion, close to the first light input surface S11, on the inclined surface S13 of the first waveguide element 110, and extends to a junction of the inclined surface S13 and the first light input surface S11 to absorb the image beam GL entering the first waveguide element 110.

In the embodiment, a width W2 of the antireflection structure 150 in a direction parallel to the arrangement direction (i.e., the first direction X) of these first light splitting elements X1, X2, X3, X4, X5 and X6 falls within a range of 15% to 35% of a width W1 of the inclined surface S13 in a direction parallel to the first direction X. The image beam GL may be absorbed only when getting close to the connected region CR with the inclined surface S13, and thus no secondarily reflected unexpected light may be generated. The image beam ML1 is reflected by the inclined surface S13 with the reflecting coating, and is reflected only once on the inclined surface S13, so that the user may not see any unexpected picture. Those skilled in the art may properly select a size of the antireflection structure 150 according to a practical condition, and there are no limits made thereto in the invention.

Referring to FIG. 6, FIG. 6 is a schematic outline diagram of a near eye display device according to an embodiment of the invention. The embodiments shown in FIG. 6 and FIG. 5 are similar. The near eye display device includes a first waveguide element 510 and second waveguide element 520 with a plurality of first light splitting elements arranged in a first direction X and second light splitting elements (not shown herein) arranged in a second direction Y respectively. The difference is a configuration position of an antireflection structure 550. Enough teachings and suggestions may be obtained from descriptions about the aforementioned embodiments for detailed implementation modes and configuration relationships.

In the embodiment, an image beam ML1 and an image beam GL, after leaving the second waveguide element 520 from a second light output surface S522, are incident to a first light input surface S51 of the first waveguide element 510, and the antireflection structure 550 (which is a light absorption coating in the embodiment) is configured within a distance d (namely between the first light input surface S51 and the second light output surface S522) to absorb the image beam GL leaving the second waveguide element 520. Specifically, the antireflection structure 550 may be attached to the first light input surface S51 and is close to a connected region of the first light input surface S51 and the inclined surface S53. In some embodiments, the antireflection structure 550 may be attached to the second light output surface S522 of the second waveguide element 520, that is, the antireflection structure 550 is on a transmission path of the image beam GL.

In the embodiment, a width W2 of the antireflection structure 550 in a direction parallel to the first direction X, for example, falls within a range of 15% to 35% of a width W1 of the inclined surface S53 in a direction parallel to the first direction X. The image beam GL may be absorbed only when being incident close to the connected region CR with the inclined surface S53, and thus the image beam GL may not be incident to the first waveguide element 510 and no secondarily reflected unexpected light may be generated. The image beam ML may not encounter the antireflection structure 550, may enter the first waveguide element 510 from the first light input surface S51 to be reflected by the inclined surface S53, and is reflected only once.

Besides the light absorption coating, the antireflection structure of the invention may also be a blunt end structure, for example, a chamfered structure or a rounded structure, and then an image beam which may generate unexpected light, when being incident to the first waveguide element, may encounter the blunt end structure and is transmitted through the blunt end structure, so that secondary reflection on the inclined surface is further eliminated to avoid generation of a ghost image picture.

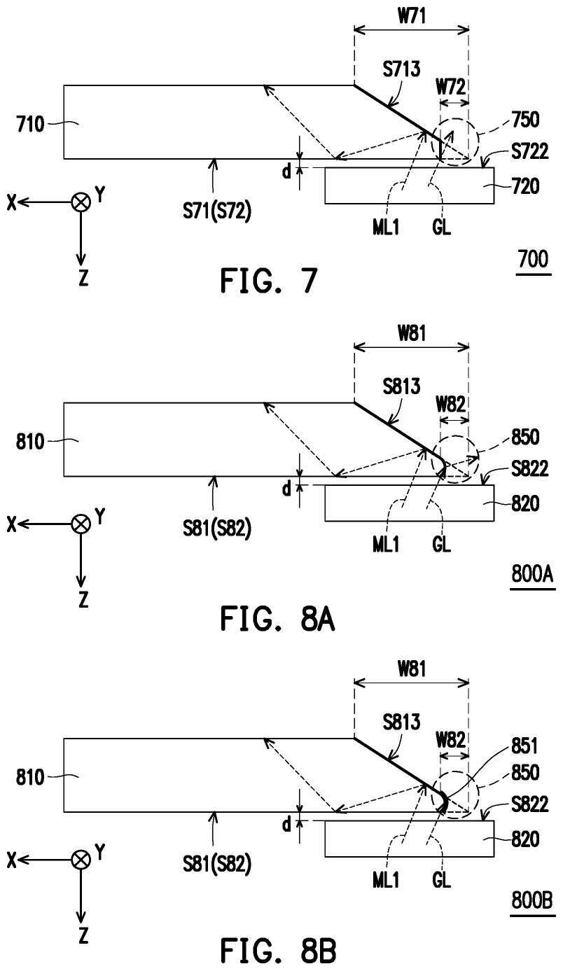

Referring to FIG. 7, FIG. 7 is a schematic outline diagram of a near eye display device according to an embodiment of the invention. The embodiment shown in FIG. 7 is similar to FIG. 5 and FIG. 6. The near eye display device includes a first waveguide element 710 and second waveguide element 720 with a plurality of first light splitting elements arranged in a first direction X and second light splitting elements (not shown herein) arranged in a second direction Y respectively. The difference is that an antireflection structure 750 in the embodiment shown in FIG. 7 is a chamfered structure. Enough teachings and suggestions may be obtained from descriptions about the aforementioned embodiments for other detailed implementation modes and configuration relationships.

In the embodiment, for example, a pointed end formed by connecting a first light input surface S71 and inclined surface S713 in the first waveguide element 710 is truncated to form the chamfered structure. A truncated width of the pointed end of the first waveguide element 710 in the first direction X is W72, and a magnitude thereof falls within a range of, for example, 15% to 35% of a width W71 of the inclined surface S713 in the first direction X. Since the pointed end of the first waveguide element 710 is truncated, an image beam GL generating unexpected light, when being incident, may encounter the antireflection structure 750 of the chamfered structure, and the image beam GL may be transmitted through the chamfered structure to eliminate a secondary reflection phenomenon on the inclined surface S713.

Referring to FIG. 8A, FIG. 8A is a schematic outline diagram of a near eye display device according to an embodiment of the invention. The embodiment shown in FIG. 8A is similar to FIG. 5 to FIG. 7. The near eye display device includes a first waveguide element 810 and second waveguide element 820 with a plurality of first light splitting elements arranged in a first direction X and second light splitting elements (not shown herein) arranged in a second direction Y respectively. The difference is that an antireflection structure 850 of the embodiment shown in FIG. 8A is a rounded structure.

In the embodiment, for example, a pointed end formed by connecting a first light input surface S81 and inclined surface S813 in the first waveguide element 810 is machined (for example, polished) to form the rounded structure. A truncated width of the pointed end of the first waveguide element 810 in the first direction X is W82, and a magnitude thereof also falls within a range of, for example, 15% to 35% of a width W81 of the inclined surface S813 in the first direction X. Since an image beam GL generating unexpected light, when being incident, encounters the antireflection structure 850 of the rounded structure, the image beam GL may be transmitted through the rounded structure to further eliminate a secondary reflection phenomenon on the inclined surface S813. Enough teachings and suggestions may be obtained from descriptions about the aforementioned embodiments for detailed implementation modes and configuration relationships and elaborations are omitted herein.

Referring to FIG. 8B, FIG. 8B is a schematic outline diagram of a near eye display device according to another embodiment of the invention. The embodiment shown in FIG. 8B is similar to FIG. 5 to FIG. 8A. The difference is that an antireflection structure shown in FIG. 8B is not only a rounded structure, but also includes an antireflection film 851. The antireflection film 851 is, for example, a light absorption coating or a black adhesive. Since an image beam GL generating unexpected light, when being incident, encounters the antireflection structure 850 where the antireflection film 851 is attached, a secondary reflection phenomenon of the image beam GL on the inclined surface S813 may be eliminated. Enough teachings and suggestions may be obtained from descriptions about the aforementioned embodiments for detailed implementation modes and configuration relationships and elaborations are omitted herein.

In some other embodiments, when the antireflection structure is a chamfered structure, the light absorption coating or the black adhesive may also be attached to a surface thereof. In addition, the antireflection structure may be properly and selectively configured on a surface of the second waveguide element according to a design requirement and a practical condition, which will not be limited in the invention. Those skilled in the art may obtain enough teachings and suggestions from the aforementioned embodiments for detailed implementation modes and configuration relationships and elaborations are omitted herein.

Based on the above, exemplary embodiments of the invention provide the near eye display device. The first waveguide element includes a plurality of light splitting elements, the inclined surface and the antireflection structure, and through the inclined surface, the image beam entering the first waveguide element from the second waveguide element is reflected and transmitted to the plurality of light splitting elements to be split by the light splitting elements and leave the first waveguide element for transmission to the projection object. The inclined surface and incident surface of the first waveguide element are connected, the antireflection structure is configured in the connected region thereof, and the antireflection structure close to the junction of the inclined surface and the incident surface eliminates the incident image beam which may generate secondarily reflected stray light, thereby improving the ghost image in the picture and providing high display quality. In conclusion, the inclined surface and incident surface of the first waveguide element are connected, and the antireflection structure configured in the connected region thereof is located on the transmission path of the image beam GL which may generate the secondarily reflected stray light.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A near eye display device, comprising a display, a first waveguide element, and a second waveguide element, wherein
the display is configured to provide an image beam,
the first waveguide element is disposed on a transmission path of the image beam and has a first light input surface, a first light output surface, an inclined surface, a plurality of first light splitting elements, and an antireflection structure,
the second waveguide element is disposed on the transmission path of the image beam and located between the display and the first waveguide element, and the second waveguide element comprises a second light input surface, a second light output surface, and a plurality of second light splitting elements, wherein the image beam enters the second waveguide element from the second light input surface, is transmitted to the plurality of second light splitting elements, and leaves the second waveguide element from the second light output surface,
wherein the image beam enters the first waveguide element from the first light input surface, and the image beam, after being reflected by the inclined surface, is transmitted to the plurality of the first light splitting elements and leaves the first waveguide element from the first light output surface, wherein a distance is provided between the first light input surface and the second light output surface,
wherein the antireflection structure is located in a connected region of the first light input surface and the inclined surface, and the antireflection structure is configured to eliminate a part of the image beam incident on the connected region of the first light input surface and the inclined surface.

2. The near eye display device according to claim 1, wherein the antireflection structure is a light absorption coating, and an absorption rate is higher than 95%.

3. The near eye display device according to claim 2, wherein the light absorption coating is disposed at an end portion close to the first light input surface on the inclined surface to absorb the part of the image beam entering the first waveguide element.

4. The near eye display device according to claim 3, wherein a width of the antireflection structure in a direction parallel to an arrangement direction of the plurality of first light splitting elements falls within a range of 15% to 35% of a width of the inclined surface in a direction parallel to the arrangement direction of the plurality of first light splitting elements.

5. The near eye display device according to claim 2, wherein the light absorption coating is disposed within the distance to absorb the image beam leaving the second waveguide element.

6. The near eye display device according to claim 5, wherein the width of the antireflection structure in the direction parallel to the arrangement direction of the multiple first light splitting elements falls within the range of 15% to 35% of the width of the inclined surface in the direction parallel to the arrangement direction of the multiple first light splitting elements.

7. The near eye display device according to claim 1, wherein the antireflection structure is a blunt end structure, wherein the part of the image beam incident on the blunt end structure is transmitted through the blunt end structure.

8. The near eye display device according to claim 7, wherein the blunt end structure is a rounded structure.

9. The near eye display device according to claim 7, wherein the blunt end structure is a chamfered structure.

10. The near eye display device according to claim 7, wherein a surface of the blunt end structure is coated with a black adhesive or a light absorption coating.

11. A near eye display device, comprising a display and a first waveguide element, wherein
the display is configured to provide an image beam,
the first waveguide element is disposed on a transmission path of the image beam and has a first light input surface, a first light output surface, an inclined surface, a plurality of first light splitting elements, and an antireflection structure;
wherein the image beam enters the first waveguide element from the first light input surface, and the image beam, after being reflected by the inclined surface, is transmitted to the plurality of first light splitting elements and leaves the first waveguide element from the first light output surface,
wherein the antireflection structure is located in a connected region of the first light input surface and the inclined surface, and the antireflection structure eliminates a part of the image beam incident from the first light input surface.

12. The near eye display device according to claim 11, wherein the antireflection structure is a light absorption coating, and an absorption rate is higher than 95%.

13. The near eye display device according to claim 12, wherein the light absorption coating is disposed at an end portion close to the first light input surface on the inclined surface to absorb the image beam entering the first waveguide element.

14. The near eye display device according to claim 13, wherein a width of the antireflection structure in the direction parallel to an arrangement direction of the plurality of first light splitting elements falls within a range of 15% to 35% of a width of the inclined surface in the direction parallel to the arrangement direction of the plurality of first light splitting elements.

15. The near eye display device according to claim 11, further comprising:
a second waveguide element, disposed on the transmission path of the image beam and located between the display and the first waveguide element, wherein the second waveguide element comprises a second light input surface, a second light output surface and a plurality of second light splitting elements, wherein the image beam enters the second waveguide element from the second light input surface, is transmitted to the plurality of second light splitting elements, and leaves the second waveguide element from the second light output surface;
wherein a distance is provided between the first light input surface and the second light output surface.

16. The near eye display device according to claim 15, wherein the antireflection structure is a light absorption coating, and the light absorption coating is disposed within the distance to absorb the part of the image beam leaving the second waveguide element.

17. The near eye display device according to claim 16, wherein a width of the antireflection structure in a direction parallel to an arrangement direction of the plurality of first light splitting elements falls within a range of 15% to 35% of a width of the inclined surface in a direction parallel to the arrangement direction of the plurality of first light splitting elements.

18. The near eye display device according to claim 11, wherein the antireflection structure is a blunt end structure, wherein the part of the image beam incident on the blunt end structure is transmitted through the blunt end structure and may not be reflected twice on the inclined surface.

19. The near eye display device according to claim 18, wherein the blunt end structure is a rounded structure or a chamfered structure.

20. The near eye display device according to claim 18, wherein a surface of the blunt end structure is coated with a black adhesive or a light absorption coating.
